(19) United States
(12) Patent Application Publication
(10) Pub. No.: US 2003/0025341 A1
(43) Pub. Date: Feb. 6, 2003

(54) Ultra high strength bumper system facebar

(76) Inventors: Joseph Kollaritsch, Clarkston, MI (US); Todd William Jilles Tjoelker, Bad Driburg (DE)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 09/919,709

(22) Filed: Aug. 1, 2001

(51) Int. Cl. B60R 19/02

(52) U.S. Cl. 293/102

(57) ABSTRACT

An improved bumper facebar, as well as a method of manufacturing the improved bumper facebar, are disclosed. The bumper facebar includes a steel body having at least one area with improved strength exhibiting selective austinitic-martensitic hardening and a Rockwell hardness greater than 41. Moreover, the steel body includes a metallic coating or plating such as chrome plating to provide a decorative finish. The austinitic-martensitic hardening is not exhibited in the steel at those points providing coupling to other objects. The method of manufacturing the improved bumper facebar includes the steps of stamping a bumper blank from a sheet of steel, forming the desired bumper shape from the bumper blank, and hardening select portions of the bumper shape by heating and cooling the select portions to produce a rockwell hardness greater than 41. The method is well adapted to receive additional steps to improve the facebar hardness and impact characteristics.

### BACKGROUND OF THE INVENTION

1. Field of the Invention

This invention generally relates to vehicle bumpers, and more particularly to a bumper facebar, and a method from producing same, having selective hardened regions to provide a more lightweight yet stronger bumper facebar.

2. Description of the Related Art

In 1997, almost 28 million bumper units were supplied to the North American OEM's. Seventy-six percent of these were steel. Eleven and one-half million of the steel units were steel reinforcement beams covered by plastic fascias, 4.0 million were painted facebars, and 5.7 were chrome-plated facebars.

Safety concerns have resulted in the bumper beam becoming a part of the structural load path. With emphasis on vehicle performance, especially fuel economy, vehicle weight considerations are becoming increasingly more important. High-strength and ultra-high-strength steels have now been developed to allow reduction in sheet metal thickness, hence weight.

The market for steel bumpers, at 300,000 tons per year, is trending increasingly towards high strength steel products. The primary design objectives of a bumper system are energy absorption under low speed impact, energy absorption under high speed impact, low weight, low cost (both initial manufacture, as well as for repair), and recyclability.

There are three well recognized primary bumper systems in use. The metal facebar design (FIG. 1), the plastic fascia with reinforcement beam design (FIG. 2), and the integrated reinforcement plastic bumper system (NOT SHOWN). A metal facebar system consists of a single metallic bumper that decorates the front or rear end of a vehicle and acts as the primary energy absorber in a collision. Due to the varying performance requirements, facebar systems are generally restricted to light trucks rather than passenger cars and also for full size vans, pickups, and sport utility vehicles for styling purposes. If stricter impact requirements are extended to the trucks and related vehicles, it is anticipated that current industry facebar systems would need to be redesigned with a reinforcement beam, a single piece construction would have to be too thick to provide a weight capable design given current strength limitations in the formable steels.

Steel facebars, for formability reasons, are usually made from steels with a low to medium yield strength. Thus, facebars are quite thick. This thickness (plus the fact facebars are deep and have large wrap around ends) gives facebars a relatively heavy weight. The art and science of sheet metal stamping processes are challenged daily to accommodate higher strength and thinner materials. Further, these materials must be transformed into more complex shapes with fewer dies and increased quality in the final part.

The total cost of coated steel facebar systems varies between $36.55 and $56.98. Material represents about 30-50% of the finished cost. Based on 100,000 units per year, tooling and equipment represent about 10% of the finished cost. Steel facebars weigh between 31 and 38 lbs. and the material costs between 0.48 and 0.50 USD per pound (40 SQ or 50 SQ grade steel). It is more expensive to chrome plate a steel facebar than to powder coat or liquid paint. The reason is largely due to the high raw material cost associated with chrome plating. The chrome plating on a steel facebar represents 40-60% of the total system cost.

The styling trend for full size vans, pickups, and sport utilities is toward rounded aerodynamic shapes. Stamped steel facebars readily accommodate this trend. Steel facebars, through the addition of paint, chrome plating, or trim, convey a light truck image. Steel facebars are more economical than facebars made from alternate materials.

As previously iterated, current industry solutions for chrome plated steel facebars are limited to strength levels less than 100 ksi. This is mainly due to the high degree of forming required during the stamping process in order to achieve the preferred aerodynamic styling. While the desire to use higher strength steels persists as a weight reduction strategy, the forming requirements have demanded a lower strength, thicker gage product.

### SUMMARY OF THE INVENTION

It is the object of this invention to provide a chrome plated bumper facebar, and a method of manufacturing a chrome plated bumper facebar with ultra high strength material properties resulting in substantial weight reduction while maintaining superior performance and appearance characteristics.

It is another object of the invention to provide a bumper facebar including a steel body having at least one area with improved strength produced by selective austinitic-martensitic hardening producing a Rockwell hardness greater than 41. Furthermore, the bumper facebar includes a metallic plating or coating attached to a predetermined surface of the steel body. Furthermore, coupling points for the bumper facebar to another object are designed so that they are absent of the austinitic-martensitic hardening exhibited at selective other locations of the bumper facebar.

It is another object of the instant invention to provide a method for manufacturing a bumper facebar. The inventive method includes the steps of stamping a bumper blank from a sheet of steel and forming a desired bumper shape from the bumper blank. Once the bumper shape has been formed, select portions of the bumper shape are hardened by heating and cooling to produce a Rockwell hardness greater than 41. Once the bumper shape has been produced and hardened, additional steps include polishing selected surfaces of the bumper shape and applying a predetermined metallic finish to complete the decorative aspect of the bumper. In a preferred embodiment, the step of forming the desired bumper shape is achieved by utilizing a cold form stamping process. Preferably, the hardening step produces a Rockwell hardness greater than 41, with a tensile strength preferably less than 95, a yield less than 65, and elongation greater than 20%. Moreover, and in addition, the method includes the step of passing the bumper blank stamped from the sheet of steel through an austenizing oven to raise the temperature of the bumper blank above a austenitic temperature. When at this temperature, the bumper blank may be inserted into a forming tool to produce the desired shape and there it is allowed to cool at a predetermined rate to create the martensitic microcrystalline structure in the steel.

The advantages of the instant invention are self apparent. Primarily, the manufacturing method produces a hardened steel bumper facebar which is substantially lighter in weight than previously steel bumper facebars, while simultaneously offering greater impact strengths and protection than previous steel facebars.

These and other objects of the invention will become readily apparent once the reader refers to the detailed description of the invention below when taken in reference to the drawing figures.

### BRIEF DESCRIPTION OF THE DRAWING FIGURES

FIG. 1 is a fragmentary sectional schematic view of a conventional chrome-plated facebar attached to a frame rail;

FIG. 2 is a fragmentary sectional schematic view of a conventional facebar mounted to a frame rail and concealed behind a plastic fascia;

FIG. 3 is a diagram illustrating one embodiment of the inventive method;

FIG. 4 is a diagram illustrating an alternate embodiment of the inventive method; and

FIG. 5 is a diagram illustrating yet another embodiment of the inventive method.

### DETAILED DESCRIPTION OF THE VARIOUS EMBODIMENTS

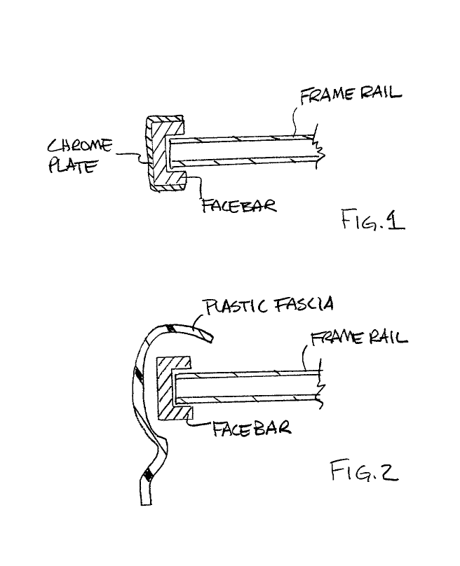

For purposes of the following description, the terms “upper,” “lower,” “left,” “rear,” “front,” “vertical,” “horizontal” and derivatives of such terms shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts. Specific dimensions and other physical characteristics relating to the embodiments disclosed herein are not to be considered as limiting, unless expressly stated otherwise.

One embodiment of the invention, shown in FIG. 1, includes the step of using conventional chrome plating techniques in conjunction with one or more thermo-mechanical forming and hardening techniques so as to produce a stamped steel facebar with ultra high strength characteristics and a chrome plated, high-quality surface finish. For the sake of simplicity, the process of chrome plating will not be described in detail herein as it is understood to those of ordinary skill in the art.

A variety of thermo-mechanical processes can be used which are dependent upon using specific grades of steel that can be readily hardened using the heretofore-described processes. Such materials generally contain low amounts of carbon and a combination of alloying elements such as manganese, chrome, and boron. All of these processes produce stamped metal products that can be chrome plated using conventional plating techniques.

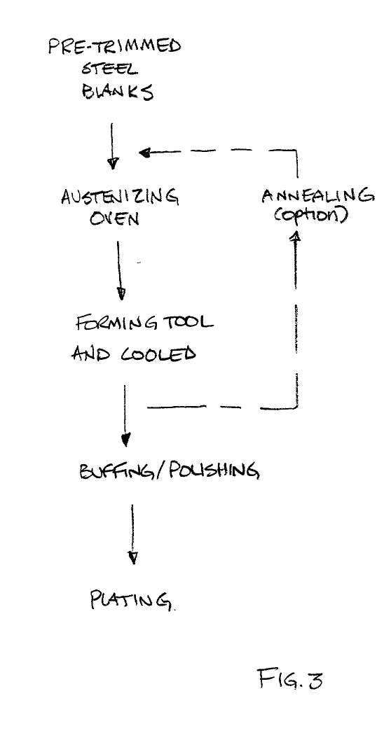

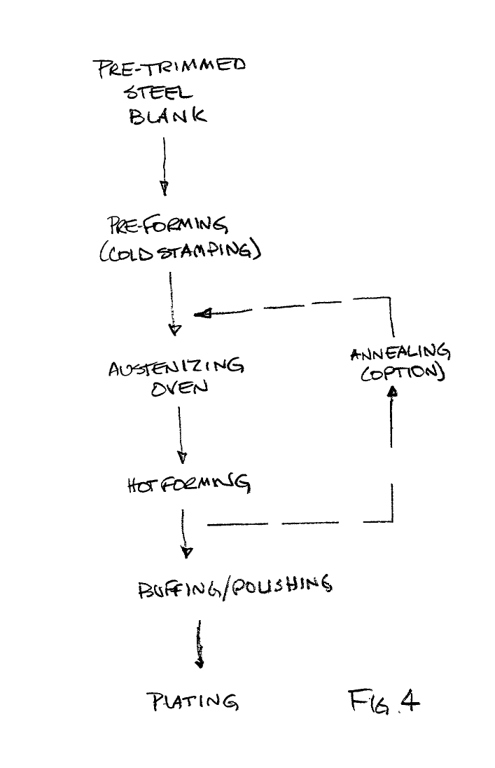

One process that can be utilized is hot forming as illustrated in FIG. 3. Pre-trimmed blanks of hardenable steel are passed through an austenizing oven to raise the temperature sufficiently for transformation. The parts are then transferred into a forming tool where they are stamped and formed while hot. The tool is kept closed and cooled internally at a predetermined rate depending on the grade of steel in order to quench the formed product and complete the transformation to a Martensitic microstructure. This microstructure transformation to Martensite is what provides the material its ultra high strength characteristics. The tool quench process has a tendency to generate a surface scale that will need to be removed by a shot blasting process. If the product is to be chrome plated, however, the surface buffing process can be used in lieu of the shot blasting process.

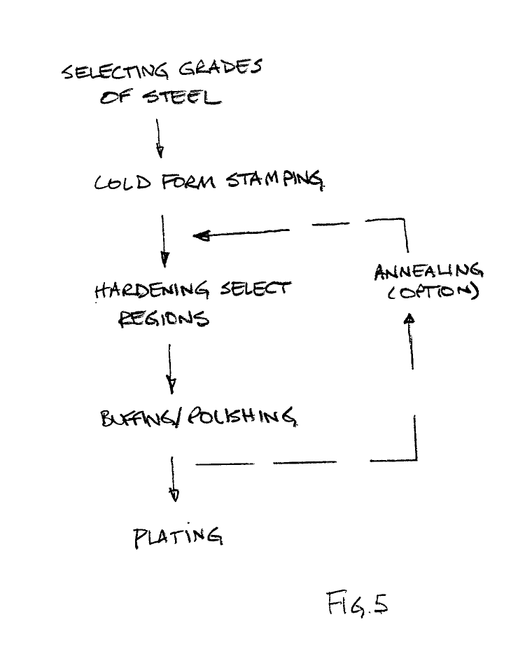

A second process shown by block diagram in FIG. 4 can be utilized using a variation of the hot forming technique. In this process, a blank of hardenable steel is pre-formed in a cold stamping tool prior to oven heating and hot forming. This variation of the hot forming process can increase the amount of form that can be generated in the product.

A third and preferred process that can be utilized to generate the ultra high strength stamping to be chrome plated is illustrated in FIG. 5. This process includes selecting grades of hardenable steels with high forming capabilities and forming the steel into desired profiles using conventional cold form stamping techniques. The formability of the steel is intended to be sufficient enough as to allow even dramatic wrap around designs to be constructed. The parts are then hardening through induction heating techniques and direct impingement water-based quenching. This hardening process has the benefit of being able to be applied over the entire part or in selected regions to localize strength characteristics. In addition, the surface condition produced through this process is improved and can be polished to the necessary finish for chrome plating using standard buffing practices.

With proper material development, the preferred process can be used to create highly formed profiles, similar to those generated using traditional high strength steels (50 ksi) already utilized in industry. However, with the addition of the hardening process, the resultant facebar exhibits the ultra high strength characteristics typically only found in the reinforcement bar products used in the bumper systems. As a result, the performance and weight of the end product can be greatly improved.

In addition, the selective hardening capability of the preferred process allows for the production of uniquely strengthened facebars with preferred soft zones and hardened zones for improved product variations. No other industrially available process allows for this single section property variation with constant blank profiles. Providing a chrome plated bumper with these properties and characteristics offer a unique and useful solution to the automobile OEM's in regard to facebar product options.

Regardless of which of the hardening processes are utilized, all will avail a product with higher properties in a chrome-plated facebar than currently offered in industry. While standard stamped profiles can be expected to have typically 50 ksi strength levels, the products generated according to the instant invention exhibit strength levels of 200 ksi or more. This dramatic increase in the strength levels available in a similar product create substantial opportunity for both improved product performance, as well as drastic weight reduction.

For Example 1 following one or more of the inventive processes, a 36-pound facebar made of 50 ksi steel, as typically seen in large truck platforms, is anticipated to realize a thirty-percent weight reduction. Based on stated OEM weight savings incentives, the net cost impact is also anticipated to be a savings over currently available techniques. Benteler Automotive of Grand Rapids, Mich., has already successfully prototyped this unique combination of thermo-mechanical forming and hardening techniques with standard chrome plating processes to create a high-quality finish, ultra high strength, chrome plated facebar.

The strength of the base material actually improved polishing processes by eliminating the chance of over buffing the material. The low carbon content provided a desirable clarity in the resultant finish. Class A quality surfaces were achieved.

Additionally, it is anticipated that the buffing process can be completed after the cold forming operation and prior to heat treatment to reduce the end polishing required for the surface specifications. Alternatively, the blanks of steel themselves can undergo a pre-polish, as completed in traditional cold formed designs, to further reduce the post-hardening surface polishing required.

The steels intended for this process have been developed by Benteler Automotive. These steels are now commercially available under proprietary release of the steel specifications to multiple domestic steel producers. The steels demonstrate excellent hardenability (41 HRC minimum at J4/16 Jominy) while providing superior forming characteristics (<65 ksi yield, <95 ksi tensile, >20% elongation, and a minimum N-Value of 0.13).

A variation of the innovative processing combination may improve the forming capability and allow even the most complex of shapes to be generated would be the incorporation of an inprocess anneal between forming operations. This is a technique currently employed by Benteler Automotive in its hydroforming applications. After the material has been formed to its limits, the mid-stream product is removed from the forming operation, annealed through subsequent heating, and the material properties are returned to their original conditions. The forming process can then be continued to produce additional shaping. Once all forming is completed, the process could be adjusted to allow for the facebar to be hardened as necessary for performance requirements and ultra high strength characteristics.

While the materials used, the forming and hardening practices utilized, and the chrome plating techniques are innovative in and of themselves, it is the challenge of combining these independent technologies into a preferred solution for chrome plated metal facebars that represents a novel solution for the automotive industry.

While vehicles utilizing chrome plated metal facebars such as trucks and full size vans are currently being designed to only 2.5 mph performance requirements, the trend towards increased safety is anticipated to raise the performance requirements of even these vehicles to the level of their passenger car equivalents at 5 mph or more. The innovation described herein provides a unique and useful means of improving the vehicle safety characteristics without the addition of secondary reinforcements or through styling sacrifices.

The above description is considered that of the different embodiments only. Modifications of the invention will occur to those skilled in the art and to those who make or use the invention. Therefore, it is understood that the embodiment shown in these drawings and described herein are merely for illustrative purposes and not intended to limit the scope of the invention, which is defined by any claims in a subsequent or related application and interpreted according to the principals of patent law, including the doctrine of equivalence.

We claim as our invention:

1. A method for manufacturing a bumper facebar, comprising the steps of:
stamping a bumper blank from a sheet of steel;
forming a desired bumper shape from said bumper blank;
hardening select portions of said bumper shape by heating and cooling said select portions to produce a Rockwell hardness greater than 41.

2. The method as defined in claim 1, further comprising the step of polishing a select surface of said bumper shape.

3. The method as defined in claim 2, further comprising the step of applying a predetermined metallic finish to said select surface of said bumper shape.

4. The method as defined in claim 3, further comprising the step of providing a sheet of steel having low carbon content.

5. The method as defined in claim 4, further comprising the step of providing a sheet of steel including alloys of manganese, chrome, and boron.

6. The method as defined in claim 5, further comprising the step of providing a sheet of steel of a grade which is hardenable having high forming capabilities.

7. The method as defined in claim 6, wherein the step of forming a desired bumper shape includes a cold form stamping process.

8. The method as defined in claim 7, wherein the step of hardening select portions of said bumper shape includes heating.

9. The method as defined in claim 7, wherein the step of hardening select portions of said bumper shape includes cooling.

10. The method as defined in claim 7, wherein the step of hardening select portions of said bumper shape includes the steps of producing select portions having a Rockwell hardness greater than 41.

11 The method as defined in claim 7, wherein the step of hardening select portions of said bumper shape includes the steps of producing a yield less than 65.

12. The method as defined in claim 7, wherein the step of hardening select portions of said bumper shape includes the steps of producing select portions having a tensile strength less than 95.

13. The method as defined in claim 1, further comprising the steps of passing said bumper blank stamped from a sheet of steel through an austenizing oven to raise the temperature of said bumper blank above a martensitic temperature.

14. The method as defined in claim 13, wherein the step of forming said desired bumper shape from said bumper blank includes placing said bumper blank into a forming tool while said temperature of said bumper blank is above said martensitic temperature.

15. The method as defined in claim 14, wherein the step of forming said desired bumper shape from said bumper blank includes the step of compressing said bumper blank in a press.

16. The method as defined in claim 15, wherein the step of hardening select portions of said bumper shape includes the step of quenching said bumper shape within said forming tool to form a martensite microstructure within said steel.

17. A bumper facebar, comprising:
a steel body having at least one area with improved strength exhibiting selective austinitic-martensitic hardening producing a Rockwell hardness greater than 41; and
a metallic coating attached to a predetermined area of said steel body.

18. The bumper facebar as defined in claim 17, wherein said metallic coating includes chrome plating.

19. The bumper facebar as defined in claim 17, wherein said selective austinitic-martensitic hardening is produced by focused induction heating to predetermined areas of said steel body.

20. The bumper facebar as defined in claim 17, wherein coupling points for the bumper facebar to another object are absent of said selective austinitic-martensitic hardening.
